(19) United States
(12) Patent Application Publication
(10) Pub. No.: US 2012/0120774 A1
(43) Pub. Date: May 17, 2012

(54) Anchor escapement and mechanical watch having the same

(76) Inventor: Hisashi Fujieda, Chiba-shi (JP)

(21) Appl. No.: 13/373,369

(22) Filed: Nov. 10, 2011

(30) Foreign Application Priority Data
Nov. 17, 2010 (JP) 2010-257221

(51) Int. Cl. G04B 15/00

(52) U.S. Cl. 368/131

(57) ABSTRACT

An anchor escapement of a mechanical watch has an escape wheel, a pallet fork engageable with or disengageable from a roller jewel of a pallet shaft having banking pin engaging portions at both sides, and pallet bridges engageable with the banking pin engaging portions at the pallet engaging portions to define the swing range of the pallet fork. One of the pallet shaft and the pallet bridges has elastic arm portions having engaging portions engageable with the engaging portions of the other member of the pallet shaft and the pallet bridge in a state in which the pallet fork fixes the escape wheel at the pallet jewel.

### BACKGROUND OF THE INVENTION

1. Field of the Invention

The present invention relates to an anchor escapement and a mechanical watch having the same.

2. Description of the Related Art

An anchor escapement having an escape wheel, a pallet fork that is engaged with and disengaged from an escape gear in the escape wheel at an entry pallet jewel and an exit pallet jewel at both ends of a pallet base and can be engaged with and disengaged from a roller at a fork-shaped pallet front end portion and a guard pin at the front end of a pallet shaft in the pallet base, and a pallet bridge that comes into contact with the pallet shaft and defines the swing range of the pallet fork is well known.

In the anchor escapement, a forcible oscillation section in which an external force is exerted with respect to the reciprocal oscillation of a balance by a hair spring is formed in an angle range (restriction angle) in which a roller jewel of the balance is engaged with the fork-shaped pallet front end portion (corner) of the pallet fork and is restricted by the pallet fork during a time span from the beginning of the release of the locked or stopped (fixed) state of the escape wheel by the pallet jewels in the pallet fork, through the completion of the release, to when rotary driving is completed with respect to the balance through the fork-shaped front end portion (corner) of the pallet shaft and the roller jewel in association to the supply of a torque to the pallet jewels by the escape wheel, and then the pallet shaft comes into contact with a solid state banking pin, accordingly, it is difficult to avoid the change in the reciprocal oscillation cycle of the balance (an escapement error occurs) (“The Theory of Horology,” by Swiss Federation of Technical Colleges, 2^{nd} English edition, April 2003, P. 149 and P. 112 (Non-patent reference 1)).

When the forcible oscillation section (the restriction angle of the balance) is constant, the ratio of the forcible oscillation section to the free oscillation section of the balance is increased as the amplitude (the maximum oscillation angle) of the balance is decreased, and the reciprocal oscillation cycle of the balance becomes liable to be changed.

In contrast to the above, there is a suggestion of a technique in which a banking pin that accepts the pallet shaft is made to be thin so that the banking pin is elastically deformed, and the banking pin is supported by a buffering substance, such as a plastic substance, in order to extend the forcible oscillation section as the amplitude (the maximum oscillation angle) of the balance is increased (JP-B-44-2754 (Patent Reference 1)).

As a result of the present inventors' attempt to verify the technique in Patent Reference 1, it was found that the suggestion in Patent Reference 1 is a good concept; however, unfortunately, the specifically suggested solution can obtain few practical effects in consideration of the size (thickness, diameter, and the like) of portable watches, such as wrist watches in current use.

That is, in the case of wrist watches and other portable watches, for example, gentleman-oriented 8 oscillation wrist watches, a force exerting to the pallet fork is, for example, about 0.17 mN (millinewton), the diameter of the banking pin should be extremely small in order to bring about elastic deformation, and there is concern that the pin itself may really be broken, which is not realistic. Conversely, if the diameter of the banking pin is made to be large to some extent to prevent the banking pin from being broken, even when a circumstance in which the amplitude (the maximum oscillation angle) of the balance is changed from 300 degrees to 180 degrees (the maximum oscillation angle range that is normally and frequently used for mechanical watches) is imagined, the change in the escapement error of the oscillation angle in accordance with an increase in the restriction angle by a change in torque that brings about the amplitude change becomes merely about 0.02 seconds/day, and the changed amount of the escapement error remains in the error range in consideration of the fact that the accuracy of a mechanical watch is evaluated as favorable if an error is about ±several seconds/day.

As described above, the suggestion in Patent Reference 1 is actually equivalent to an impractical theory, and cannot be a realistic solution.

### SUMMARY OF THE INVENTION

It is an aspect of the present application to provide an anchor escapement that can substantially change the restriction angle of the balance according to the amplitude of the balance (the maximum oscillation angle), a speed controlling escapement mechanism and a mechanical watch both of which have the anchor escapement.

The anchor escapement of the application is an anchor escapement having an escape wheel having an escape gear, a pallet fork that is swingably supported around a pallet staff, engaged with or disengaged from the escape gear at an entry pallet jewel and an exit pallet jewel at both ends of a pallet base, and can be engaged with or disengaged from a roller jewel of a roller at a fork-shaped pallet front end portion present at the front end of a pallet shaft having banking pin engaging portions at both sides, and pallet bridges that are engaged with the banking pin engaging portions at a pair of the pallet engaging portions and define the swing range of the pallet fork, in which any one member of the pallet shaft and the pallet bridge has elastic arm portions that are connected to the side wall of the above member at the base end portion and extended along the side wall from the base end portion to the front end portion, the front end portion of the elastic arm portion forms the engaging portion of the above member, and the elastic arm portion is elastically deformed and the engaging portion at the front end of the elastic arm portion is engaged with the engaging portion of the other member of the pallet shaft and the pallet bridge in a state in which the pallet fork fixes the escape gear at the pallet jewel against a torque.

Since “any one member of the pallet shaft and the pallet bridge has elastic arm portions that are connected to the side wall of the above member at the base end portion and extended along the side wall from the base end portion to the front end portion, the front end portion of the elastic arm portion forms the engaging portion of the above member, and the elastic arm portion is elastically deformed and the engaging portion at the front end of the elastic arm portion is engaged with the engaging portion of the other member of the pallet shaft and the pallet bridge in a state in which the pallet fork fixes the escape wheel at the pallet jewel against a torque” in the anchor escapement of the application, the restriction angle of the balance is increased by a rotation angle necessary to remove the elastic deformation state of the elastic arm portion. Here, since the degree of the elastic deformation of the elastic arm portion is increased as the torque added to the escape wheel is increased, the restriction angle of the balance is also increased as the torque added to the escape wheel is increased. That is, since the pallet jewel fixes (stops) or locks the escape wheel in a state in which the elastic arm portion is significantly deformed elastically as the torque added to the escape wheel is increased, the restriction angle of the balance is increased by the rotation angle necessary to remove the elastic deformation state of the elastic arm portion as the torque added to the escape wheel is increased. On the other hand, when the torque added to the escape wheel is increased, energy transmitted to the balance through the pallet fork is also increased, and the amplitude (maximum oscillation angle) of the balance is also increased.

Therefore, as the torque added to the escape wheel is increased, and the amplitude (maximum oscillation angle) of the balance is increased, the roller jewel of the balance is engaged with the fork-shaped pallet front end portion (corner) of the pallet fork, and the angle range (restriction angle) restricted by the pallet fork is increased. That is, in the anchor escapement of the application, unlike the case of an ordinary anchor escapement in the related art having no elastic arm portion, since the restriction angle of the balance is increased as the amplitude (maximum oscillation angle) of the balance is increased, the deviation or escapement error in the periodicity of an escapement due to the amplitude change of the balance can be reduced.

Furthermore, in the anchor escapement of the application, since an increase or decrease in the restriction angle is realized by an increase or decrease in the degree of the elastic deformation of “any one member of the pallet shaft and the pallet bridge which is an elastic arm portion that is connected to the side wall of the above member at the base end portion and extended along the side wall from the base end portion to the front end portion,” unlike the case of Patent Document 1 in which the elastic curving of the banking pin is presumed, the elastic arm portion is formed along the side walls of watch parts extended in the widening direction of the extended face on a supporting substrate like the ground plane of a watch, it is possible to make the elastic arm portion easily extended (furthermore thinly and slimly when desired) and easily bent. Therefore, when the torque added to the escape wheel is changed and the amplitude of the balance is changed, the restriction angle of the balance can also be changed significantly according to the change of the torque added to the escape wheel, and the change of the escapement error due to the torque change (amplitude change) can be reduced. Meanwhile, herein, “(the elastic arm portion) is extended “along” the side wall” refers to the fact that the elastic arm portion is extended in the extension direction of the side wall as a whole, and, typically, the gap between the elastic arm portion and the facing side wall is almost constant, but may be changed when desired (for example, the elastic arm portion may be meandered so that the effective length of the elastic arm portion is extended).

In the anchor escapement of the application, for example, a buffering material that absorbs oscillation is provided between the side wall of the above member and the elastic arm portion connected to the side wall.

In this case, since it is possible to suppress to the minimum extent the recovering of the deformed elastic arm portion by the elastic force thereof or elastic oscillation, the restriction angle can be reliably controlled. Here, the buffering material is made of, for example, a material having plasticity. Meanwhile, the buffering material is typically provided between the base end portion of the elastic arm portion and the side wall to which the elastic arm portion is mounted so as not to prevent the deformation of the elastic arm portion. However, in some cases, the buffering material may be provided at a place somewhat away from the base end portion. Meanwhile, when the elastic force of the elastic arm portion can actually be ignored, the buffering material may be removed.

In the anchor escapement of the application, typically, the elastic arm portion is formed at both side portions of the pallet shaft.

In this case, since the elastic arm portion can be formed along the side wall (of the main body) of the pallet shaft, it becomes possible to form the elastic arm portion using the length of the pallet shaft. That is, since the elastic arm portion can be made to be long and be deformed with a weak force by using the length of the pallet shaft, the restriction angle of the balance can be relatively significantly changed, and the escapement error can be adjusted relatively significantly.

Meanwhile, in the above case, the anchor escapement of the application is typically configured so that the elastic arm portion is extended from the end portion close to the pallet staff among the respective side portions of the pallet shaft along both side portions of the pallet shaft toward the front end portion of the pallet shaft, a gap is formed between each elastic arm portion and the side portion facing the elastic arm portion of the pallet shaft, the respective arm portions located ahead of the swing direction are elastically deformed when the pallet fork is swung around the pallet staff, and the pallet fork is engaged with the pallet engaging portion adjacent to the pallet bridge at the external face of the portion close to the front end of the elastic arm portion.

In this case, it is easy to extend the elastic arm portion so as to be easily bent.

In the above case, in the anchor escapement of the application,

(1) the pallet bridge may have a solid state banking pin, or

(2) the pallet bridge may be composed of a banking pin.

In the anchor escapement of the application, in the case of the former (1), the shape or length of the elastic arm portion is easily adjusted.

In the anchor escapement of the application, in the case of the latter (2), since there is no need for elastically deforming the banking pin itself, the banking pin can be made to be sufficiently thick, and the balance restriction angle can be easily and reliably adjusted in comparison to the case of Patent Document 1. In addition, when the banking pin has an eccentric structure, the restriction beginning angle place itself can be adjusted by changing the eccentric direction of the banking pin. In that case, the main body of the banking pin may be supported by the eccentric buffering material.

As described above, in the anchor escapement of the application, the elastic arm portion may have a solid state banking pin at the pallet bridge and be formed at both side wall portions of the recess portion of the solid state banking pin instead of being formed at both side portions of the pallet shaft.

In that case, since the pallet bridge having a relatively high shape freedom degree may have the elastic arm portion at the position of the solid state banking pin, an elastic arm portion having desired characteristics is easily and reliably formed. Meanwhile, in this case, typically, the elastic arm portion is formed so as to be extended from the base end portion of the pallet shaft in the almost opposite direction to the extension direction toward the front end portion of the pallet shaft. In that case, a concern of the interruption with the pallet shaft can be suppressed to the minimum extent.

In the anchor escapement of the application, the elastic arm portion is formed by, for example, UV-LIGA, reactive ionic etching, or laser processing.

In that case, it is easy to carry out fine processing precisely, and a thin, fine, and long arm portion having a relatively low stiffness is easily formed. Meanwhile, the elastic arm portion and the side wall connected to the elastic arm portion at the base end portion may be made of the same material or different materials. In the latter case, the elastic arm portion is formed by, for example, electrocasting by UV-LIGA or the like.

The speed controlling escapement mechanism of the application has the anchor escapement as described above in order to achieve the object. In addition, the mechanical watch of the application has the anchor escapement as described above in order to achieve the object.

### BRIEF DESCRIPTION OF THE DRAWINGS

FIG. 1 is a plane descriptive view showing an anchor escapement of a speed controlling escapement mechanism of a mechanical watch of a preferred example of the invention;

FIG. 2 is a descriptive view showing the relationship between the angle position of the roller jewel and the state of the balance in the speed controlling escapement mechanism having the anchor escapement of FIG. 1;

FIG. 3 is the same plane descriptive view as FIG. 1 showing the stoppage release beginning state in the speed controlling escapement mechanism of a preferred example of the invention having an anchor escapement of a preferred example of the invention for which the restriction angle is made to be larger by 8 degrees than the same apparatus in the related art;

FIG. 4 is the same plane descriptive view as FIG. 3 regarding a state in which the bending of the elastic arm portion is removed in an ongoing stoppage release state in the speed controlling escapement mechanism of FIG. 3 (FIG. 4 shows the same state as FIG. 1);

FIG. 5 is the same plane descriptive view as FIG. 3 showing a state in which the release of stoppage is just finished in the speed controlling escapement mechanism of FIG. 3;

FIG. 6 is the same plane descriptive view as FIG. 3 showing an impact beginning state in the speed controlling escapement mechanism of FIG. 3;

FIG. 7 is the same plane descriptive view as FIG. 3 showing a pressing beginning state of an elastic arm portion in the speed controlling escapement mechanism of FIG. 3;

FIG. 8 is the same plane descriptive view as FIG. 3 showing a state in which the pressing of the elastic arm portion is just finished in the speed controlling escapement mechanism of FIG. 3;

FIG. 9 is the same plane descriptive view as FIG. 3 showing a state in which the balance is in a free oscillation state in the speed controlling escapement mechanism of FIG. 3;

FIG. 10 is a plane descriptive view showing an enlarged part of the anchor escapement of FIG. 3;

FIG. 11 is the same plane descriptive view as FIG. 1 showing a state of a case in which the restriction angle is increased by 4 degrees by the elastic arm portion in the speed controlling escapement mechanism having the anchor escapement of FIG. 1 in comparison to an anchor escapement having no elastic arm portion;

FIG. 12 is a graph showing the relationship between the amplitude of the balance and the balance restriction angle;

FIG. 13 is a graph showing the relationship between the amplitude of the balance and the escapement error;

FIG. 14 is the same plane descriptive view as FIG. 1 regarding a speed controlling escapement mechanism of another example of the invention having an anchor escapement of another example of the invention having the elastic arm portion at a solid state banking pin; and

FIG. 15 is the same plane descriptive view as FIG. 1 regarding a speed controlling escapement mechanism of still another example of the invention having an anchor escapement of still another example of the invention composed of a banking pin as a bank.

### DETAILED DESCRIPTION OF THE PREFERRED EMBODIMENTS

A preferred embodiment of the invention will be described based on preferred examples shown in the attached drawings.

### Examples

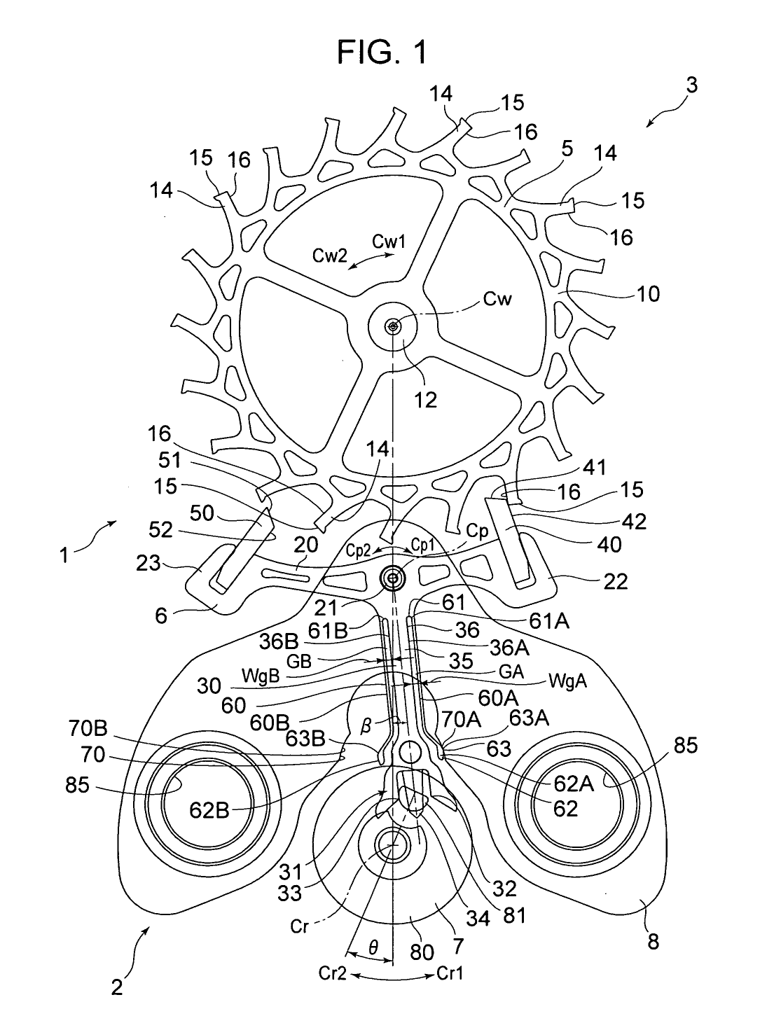

FIG. 1 shows a speed controlling escapement mechanism 2 having an anchor escapement 1 of a preferred example of the invention. FIG. 1 shows only the portion of the speed controlling escapement mechanism 2 of a mechanical watch 3 having the speed controlling escapement mechanism 2. The speed controlling escapement mechanism 2 has an escape wheel 5, a pallet fork 6, and a balance 7. The balance 7 can rotate or swing reciprocally around the central shaft line Cr in Cr1 and Cr2 directions.

The escape wheel 5 has an escape gear 10 that can rotate around the central shaft line Cw in Cw1 and Cw2 directions and an escape pinion 12. The escape gear 10 has a number of teeth 14, and each of the teeth (hereinafter referred to as an “escape tooth”) 14 has an impact face 15 and a fixing face or locking face 16. The escape wheel 5 is bonded with a movement barrel complete (not shown) at the escape pinion 12 through a train wheel, and receives a torque in a Cw1 direction at all times through a spiral spring (not shown) in the movement barrel complete.

The pallet fork 6 has a pallet base 20, a pallet shaft 30, and a pallet staff 21, and can freely swing around the central shaft line Cp of the pallet staff 21 in Cp1 and Cp2 directions. An entry pallet jewel 40 and an exit pallet jewel 50 are mounted in the end portions 22 and 23 of the pallet base 20. The entry pallet jewel 40 and the exit pallet jewel 50 have impact receiving faces 41 and 51 and locking faces, that is, fixing faces or stopping faces 42 and 52, respectively. Fork-shaped pallet front end portions or corners 32 and 33 and a guard pin 34 that form a pallet box 31 are formed at the front end of the pallet shaft 30.

The pallet shaft 30 has elastic arm portions 60A and 60B (denoted by a reference symbol of ‘60’ when both are not differentiated or are collectively referred to) at both side portions 36A and 36B (denoted by a reference symbol of ‘36’ when both are not differentiated or are collectively referred to) of a shaft main body 35. The elastic arm portions 60A and 60B are integrally connected with the shaft main body 35 at base end portions 61A and 61B (denoted by a reference symbol of ‘61’ when both are not differentiated or are collectively referred to) close to the pallet staff 21, and are extended along the side portions 36A and 36B from the base end portions 61A and 61B to front end portions 62A and 62B (denoted by a reference symbol of ‘62’ when both are not differentiated or are collectively referred to) with gaps GA and GB (denoted by a reference symbol of ‘G’ when both are not differentiated or are collectively referred to) therebetween so as to face the side portions 36A and 36B of the pallet shaft main body 35 through the gaps GA and GB having an almost constant width WgA and WgB (denoted by a reference symbol of ‘Wg’ when both are not differentiated or are collectively referred to), respectively. Meanwhile, the elastic arm portions 60A and 60B may be extended, for example, in a meandering state (that is, in a state in which the gaps between the elastic arm portions 60A and 60B and the side portions 36A and 36B of the pallet shaft main body 35 are changed, respectively) so that the length of springs can be increased, instead of being extended in parallel as shown in the drawing so that the gaps between the elastic arm portions 60A and 60B and the side portions 36A and 36B of the pallet shaft main body 35 become almost constant, respectively.

A pallet bridge 8 having solid state banking pins 70A and 70B that regulate the swing range of the pallet fork 6 in the Cp1 and Cp2 directions at both sides in the front end portion of the pallet shaft 30 is provided in the place of the pallet shaft 30, and is fixed to a supporting substrate like a ground plane by set screws and the like mounted in mounting holes 85 and 85.

Formed in the vicinity of the front end portions 62A and 62B of the elastic arm portions 60A and 60B are banking pin contact portions 63A and 63B (denoted by a reference symbol of ‘63’ when both are not differentiated or are collectively referred to) as banking pin engaging portions that come into contact with the solid state banking pins 70A and 70B, respectively, and come into contact with and are pressed on the solid state banking pins 70A and 70B that act as the corresponding pallet engaging portions of the elastic arm portions 60A and 60B in the pallet fork 6 when the pallet fork 6 is swung around the pallet staff 21 in the Cp2 and Cp1 directions under the torque action of the escape wheel 5.

The pallet fork 6 is engaged with the balance 7, more specifically, with a roller jewel 81 of a roller 80 in the balance 7 at the pallet box 31 or the fork-shaped pallet front end portion or the corners 32 and 33 that form the pallet box 31.

The elastic arm portions 60A and 60B present at both sides of the pallet shaft 30 of the pallet fork 6 are slim, thin, and long, and can be bent with a small force. In a state in which the locking face 42 or 52 of the pallet jewel 40 or 50 in the pallet fork 6 and the locking face 16 of the escape tooth 14 in the escape wheel 5 are engaged with each other, the pallet engaging portion 63A or 63B of the pallet fork 6 is pressed on the pallet engaging portion (solid state banking pin) 70A or 70B of the pallet bridge 8, and the torque of the spiral spring (not shown) applied to the escape tooth 14 in the escape wheel 5 and the torque of the elastic arm portion 60A or 60B in an elastically deformed state match. Each of the elastic arm portions 60A and 60B is, for example, about 0.06 mm in width, about 0.03 mm in thickness, and about 1.4 mm in length. The portion of the pallet shaft 30 of the pallet fork 6 having the elastic arm portions 60A and 60B can be formed by etching used in electrocasting, in which LIGA is used, or a process for manufacturing silicon wafers (for example, reactive ion etching) or the like, or processing using a laser beam (laser processing). As long as the elastic arm portions 60A and 60B can be formed to be thin, slim, and long so that the stiffness of the elastic arm portions 60A and 60B is sufficiently decreased, the elastic arm portions 60A and 60B may be formed to be added with respect to the pallet shaft main body 35 by electrocasting and the like, or may be formed by removing the portion between the elastic arm portions and the pallet shaft main body 35 by etching and other methods.

For example, when the elastic arm portions are formed to be added by, for example, electrocasting, the main body 35 of the pallet shaft 30 and the elastic arm portions 60A and 60B may be formed of different materials, such that the pallet shaft main body 35 and the like are formed of Ni (nickel), and the elastic arm portions 60A and 60B are formed of P—Ni (an phosphorous and nickel alloy).

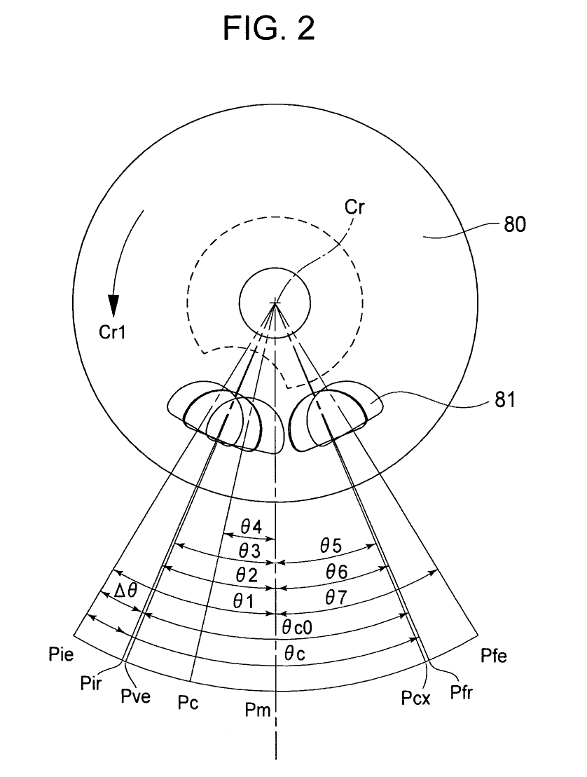

In the speed controlling mechanism 2 having the anchor escapement 1, the shape or relative position of relevant parts are, for example, shapes or positions for realizing the angle relationship shown in FIG. 2.

FIG. 2 shows the changes in the oscillation angle θ of the balance 7 around the central shaft line Cr of the roller jewel 81 of the roller 80.

When the middle position Pm is determined, the oscillation angle θ is 0 (θ=0) at the criterion position, and the respective angles θ1, θ2, and θ4 are as follows.

The angle position Pie (θ=θ1) is an angle position where the release of locking or stopping of the escape tooth 14 of the escape wheel 5 from the pallet jewel 40 or 50 in the pallet fork 6 begins. (In this state, the related elastic arm portion 60A or 60B is pressed and elastically deformed on the corresponding side portion 36A or 36B in the pallet shaft 30 in accordance with a torque added from the escape tooth 14 of the escape wheel 5 through the pallet jewel 40 or 50.)

The angle position Pir (θ=θ2) is a state in which the elastic deformation of the elastic arm portion 60A or 60B just disappears as the release of locking or stopping proceeds. This state or position is a state in which the gap GA or GB between the elastic arm portion 60A or 60B and the related side portion 36A or 36B in the main body 35 of the pallet shaft 30 returns to an almost constant WgA or WgB, and matches the position where the outer surface of the elastic arm portion 36A or 36B present at the position of the side surface of the pallet shaft 30 of the related art having no gap GA or GB is in contact with the solid state banking pin 70A or 70B that acts as the corresponding pallet engaging portion.

The angle position Pc (θ=θ4) is an angle position where the release of locking or stopping (escape from a fixing state) is completed, and then impact by the escape tooth 14 of the escape wheel 5 on the pallet jewel 40 or 50 in the pallet fork 6 (supply of an external force) begins.

The angle position Pm (θ=θ0) is the middle position as described above.

The angle position Pcx (θ=θ5) is an angle position where the impact of the escape tooth 14 of the escape wheel 5 on the pallet jewel 40 or 50 in the pallet fork 6 is finished. Meanwhile, the position of θ3=θ5 located on the opposite side of the middle position Pm is the angle position Pve.

The angle position Pfr (θ=θ6) is an angle position where the banking pin engaging portion 63B or 63A of the elastic arm portion 60B or 60A extending along the side portion 36B or 36A of the pallet shaft 30 in the pallet fork 6 starts to come into contact with the solid state banking pin 70B or 70A that acts as the corresponding pallet engaging portion. Since the pallet fork 6 can rotate actually freely and, when exceeding the middle position Pm, can rotate more easily than the balance 7 that receives a force in the returning direction by the spiral spring, the pallet front end portion or the corner 32 or 33 in the pallet box 31 continuously exerts a force with respect to the roller jewel 81 in the balance 7 until the roller jewel 81 in the balance 7 reaches the angle position Pfr (θ=θ6), and the restriction angle θc=θ1+θ6=(θ2+θ6)+Δθ. Here, θ6=θ2.

Meanwhile, since the (θ2+θ6) is the restriction angle θc0 of a speed controlling escapement in the related art having an anchor escapement in the related art having no elastic arm portion 60, the restriction angle θc becomes “θc0+Δθ,” that is, the sum of the restriction angle θc0 of the related art and an increase in the restriction angle Δθ (=θ1-θ2).

The angle position Pfe (θ=θ7) is an angle position where pressing is completed by pressing the banking pin engaging portion 63B or 63A of the elastic arm portion 60B or 60A on the solid state banking pin 70B or 70A that acts as the corresponding pallet engaging portion up to a position at which the escape tooth 14 in the escape wheel 5 matches a torque that presses the locking face 52 or 42 of the other pallet jewel 50 or 40 in the pallet fork 6 at the locking face 16. Here, actually, θ7=θ1.

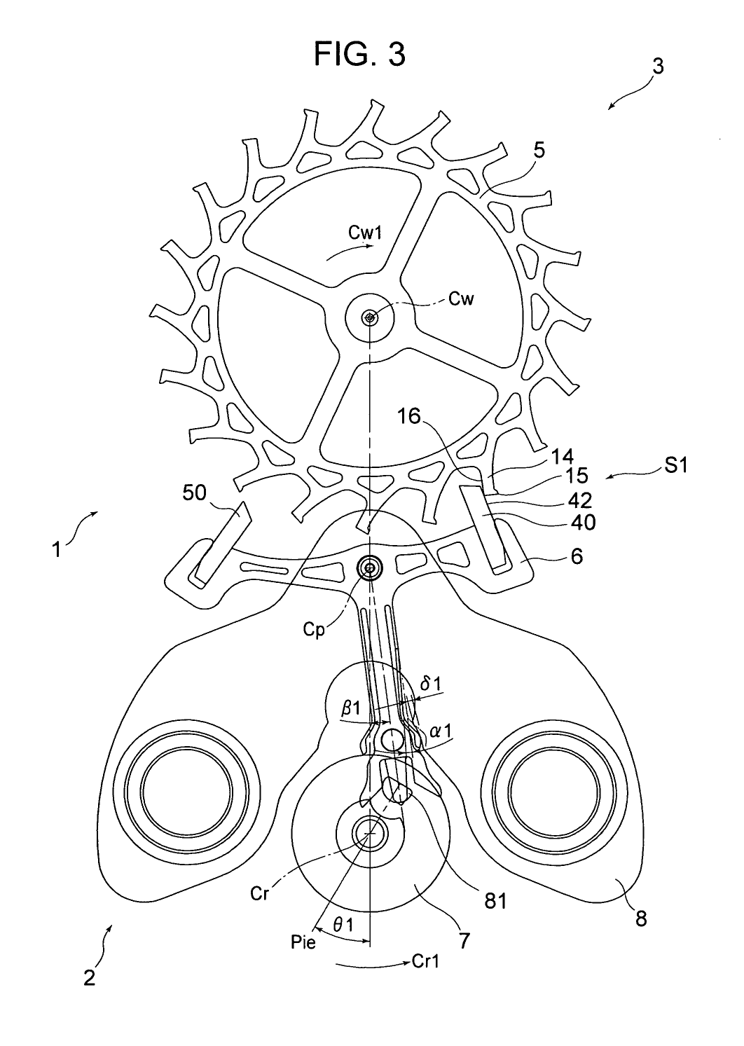

The operation of the speed controlling escapement mechanism 2 having the anchor escapement 1 configured as above will be described in more detail based on FIGS. 3 to 9.

In this example, the rotation angle of the balance 7 at which the banking pin engaging portion 63 of the pallet shaft 30 and the solid state banking pin 70 that acts as the pallet engaging portion remain in a contact state by the elastic deformation of the elastic arm portion 60, that is, an increase Δθ (=θ1-θ2) in the restriction angle θc is 8 degrees.

FIG. 3 is in a state in which the roller jewel 81 in the balance 7 comes into the pallet box 31 from the free oscillation state and is going to begin the release of the locking (stoppage release) of the pallet fork 6 by the escape wheel 5, and corresponds to the stoppage release beginning position Pie in FIG. 2. FIG. 3 shows a state in which the roller jewel 81 of the balance 7 is rotated in the Cr1 direction and brought into contact with the pallet front end portion 33 of the pallet box 31, thereby beginning to supply rotation in the Cp1 direction with respect to the pallet shaft 30 in a state in which the escape wheel 5 intermittently rotating in the Cw1 direction under the action of a torque from the spiral spring (not shown) is engaged with the entry pallet jewel 40 at the locking face 16 of the escape tooth 14, that is, the stoppage release beginning state S1.

In the stoppage release beginning state S1, the speed controlling escapement mechanism 2 including the anchor escapement 1 is present at a slant position in which the pallet shaft 30 is inclined in the Cp2 direction by an angle β=β1 around the central shaft line Cp as shown in FIG. 3, and the roller jewel 81 of the roller 80 in the balance 7 is in the middle of rotating in the Cr1 direction and reaches a position deviated in the Cr2 direction by an angle θ=θ1 in comparison to the middle position Pm.

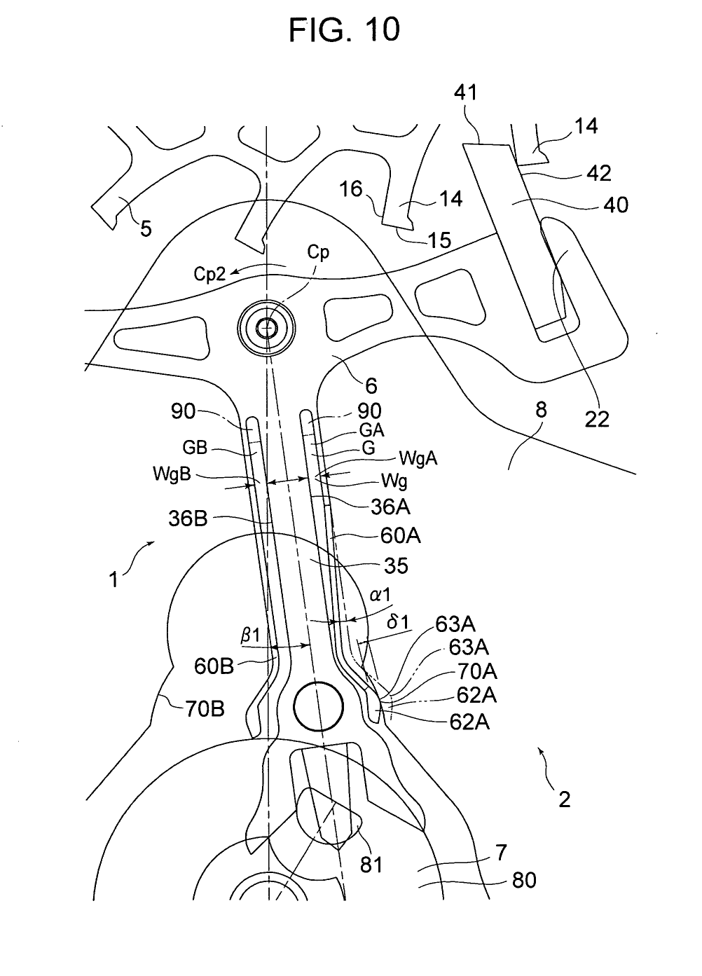

Meanwhile, as clear from FIG. 3 and FIG. 10 showing an enlarged part thereof, in this state, the elastic arm portion 60A is pressed on the solid state banking pin 70A at the banking pin engaging portion 63A and bent by an angle α=α1 so as to be deformed by a displacement amount δ=δ1 under the action of a torque in the Cp2 direction which the entry pallet jewel 40 receives from the escape wheel 5. That is, the bending amount (α) or displacement amount (δ) of the elastic arm portion 60A is increased as the torque transmitted from the spiral spring (not shown) to the escape wheel 5 is increased, and, accordingly, the angle Δθ (=θ1-θ2) between the positions Pie and Pir in FIG. 2 is increased. That is, the bending amount (α or δ) of the elastic arm portion 60A is increased as the torque of the spiral spring (not shown) is increased, and the balance 7 is engaged with the pallet box 31 of the pallet fork 6 so as to be restricted by the pallet fork 6 at an early timing, thereby increasing the increase Δθ (=θ1-θ2) in the restriction angle θc.

For example, in FIG. 3, θ1=31 degrees, β1=about 7.5 degrees, α1=about 3 degrees, δ1=about 6×10⁻² mm, and Δθ (=θ1-θ2)=8 degrees.

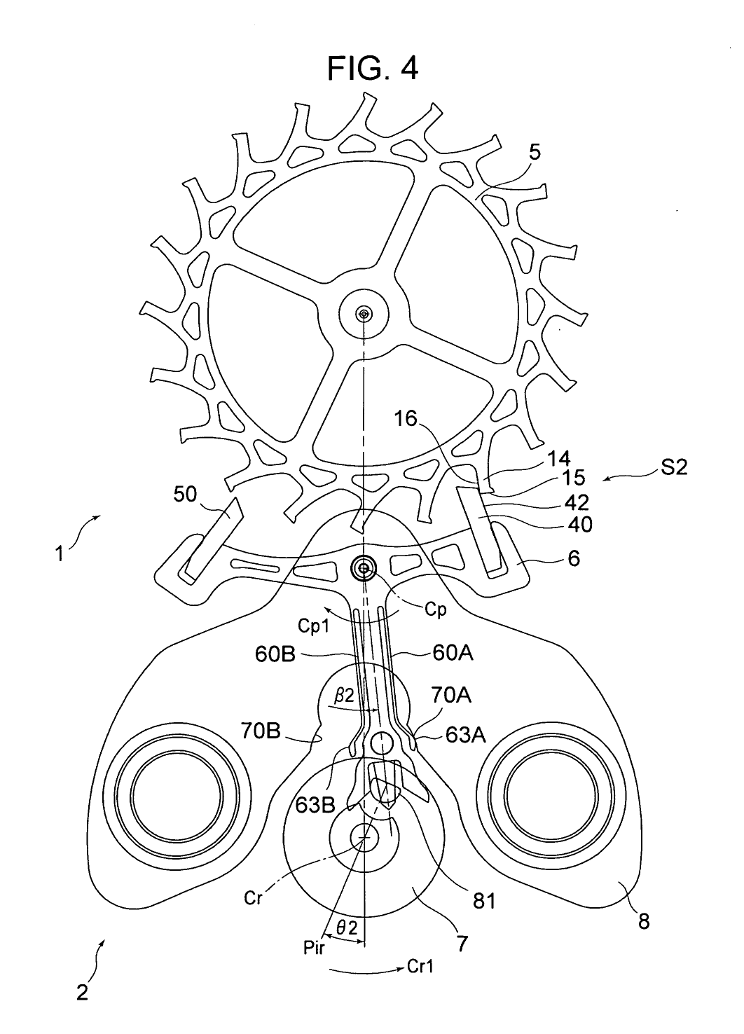

When the roller jewel 81 of the balance 7 is rotated in the Cr1 direction and reaches the angle position Pir with an angle θ=θ2 as shown in FIG. 4, the bending of the elastic arm portion 60A of the pallet shaft 30 of the pallet fork 6 just disappears, and a state S2 in which the banking pin engaging portion 63A at the front end of the elastic arm portion 60A comes into light contact with the solid state banking pin 70A is formed. At this time, the slant angle β of the pallet shaft 30 becomes β2. In this example, for example, θ2=23 degrees, and β2=about 5.8 degrees.

When the roller jewel 81 in the balance 7 is rotated in the Cr1 direction within the angle Δθ (=θ1-θ2=31-23=8 (degrees)) from the state S1 (θ=θ) to the state S2 (θ=θ2), since the elastic arm portion 60A is present in the pallet shaft 30, the pallet shaft 30 is excessively inclined by Δβ=(β1-β2=about 7.5-about 5.8=about 1.7 (degrees)), and the roller jewel 81 in the balance 7 is excessively engaged with and restricted at the pallet front end portion 33 of the pallet box 31 at the front end of the pallet shaft 30 by Δθ=8 degrees. That is, in the anchor escapement 1, as the torque of the spiral spring is increased, the elastic displacement amount α1 of the elastic arm portion 60 is increased, and the slant angle range Δβ of the pallet shaft 30 is increased, the time period or angle Δθ in which the roller jewel 81 is restricted in the pallet front end portion 33 is increased during the reciprocal swing of the balance 7 in the Cr1 and Cr2 directions.

Meanwhile, this ongoing stoppage release state S2 corresponds to a state in which the release of stoppage begins in the case of an anchor escapement having an ordinary pallet shaft in the related art in which no space G is present between the elastic arm portion 60 and the pallet shaft 30, and the elastic portion 60 forms an integral stiff portion with the pallet shaft 30. That is, in the case of an ordinary anchor escapement in the related art having an ordinary pallet shaft in the related art having no elastic arm portion, the release of stoppage begins from the state S2, and the restriction of the balance 7 also begins from the state S2, that is, the angle θ2 present in the angle position Pir, and the roller jewel is freely oscillated without being restricted until the roller jewel reaches the angle θ2 present in the angle position Pir.

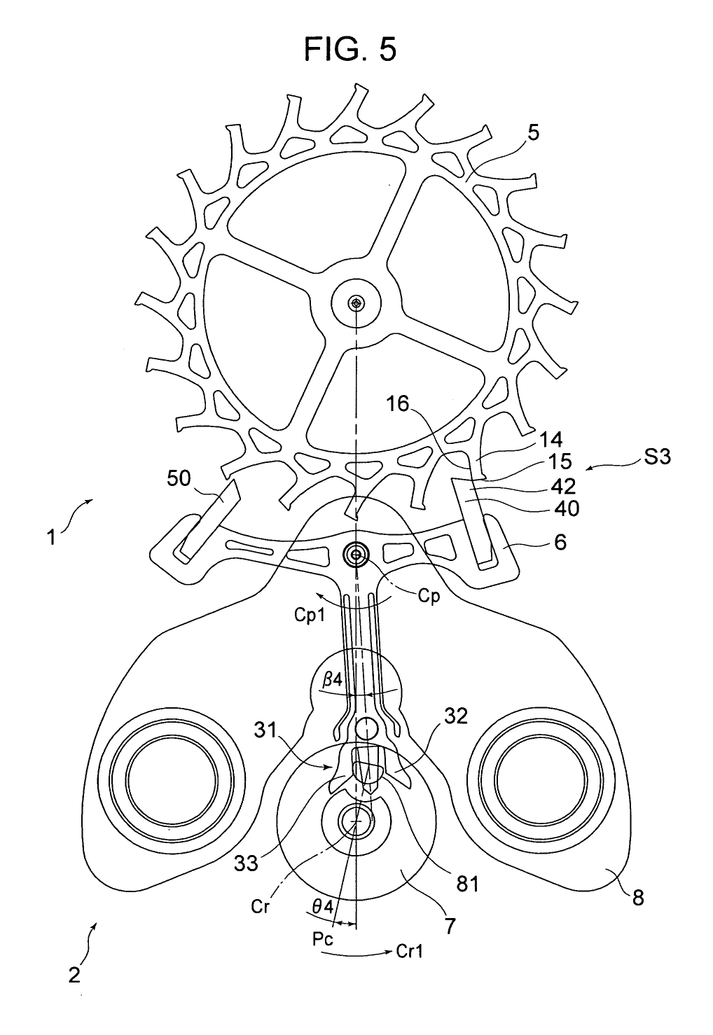

When the roller jewel 81 in the balance 7 is further swung in the Cr1 direction, and reaches the angle position Pc, that is, the angle θ=θ4 as shown in FIG. 5, the engagement or fixing between the locking face 42 of the entry pallet jewel 40 of the pallet fork 6 swung in the Cp1 direction by the roller jewel 81 and the locking face 16 of the escape tooth 14 of the escape wheel 5 is completed. Here, for example, θ4=about 12.6 degrees, and β4=about 3.4 degrees.

Since the balance 7 presses and returns the escape wheel 5 in the Cr2 direction in any way through the pallet fork 6 by the roller jewel 81 for the release of stoppage while the roller jewel 81 reaches from the state S1 present in the angle position Pie (θ=θ1) to the state S3 present in the angle position Pc (θ=θ4), the balance 7 loses energy by that amount. That is, with regard to the time period in which the balance 7 loses energy, in the speed controlling escapement mechanism 2 having the anchor escapement 1, the balance 7 presses and returns the escape wheel 5 in the Cr2 direction through the pallet fork 6 for the release of stoppage, and the balance 7 loses energy by that amount not only in the period in which the roller jewel reaches the state S3 of the angle position Pc (θ=θ4) from the state S2 of the angle position Pir (θ=θ2), but also in a period from the state S1 of the angle position Pie (θ=θ1) to the state S2 of the angle position Pir (θ=θ2).

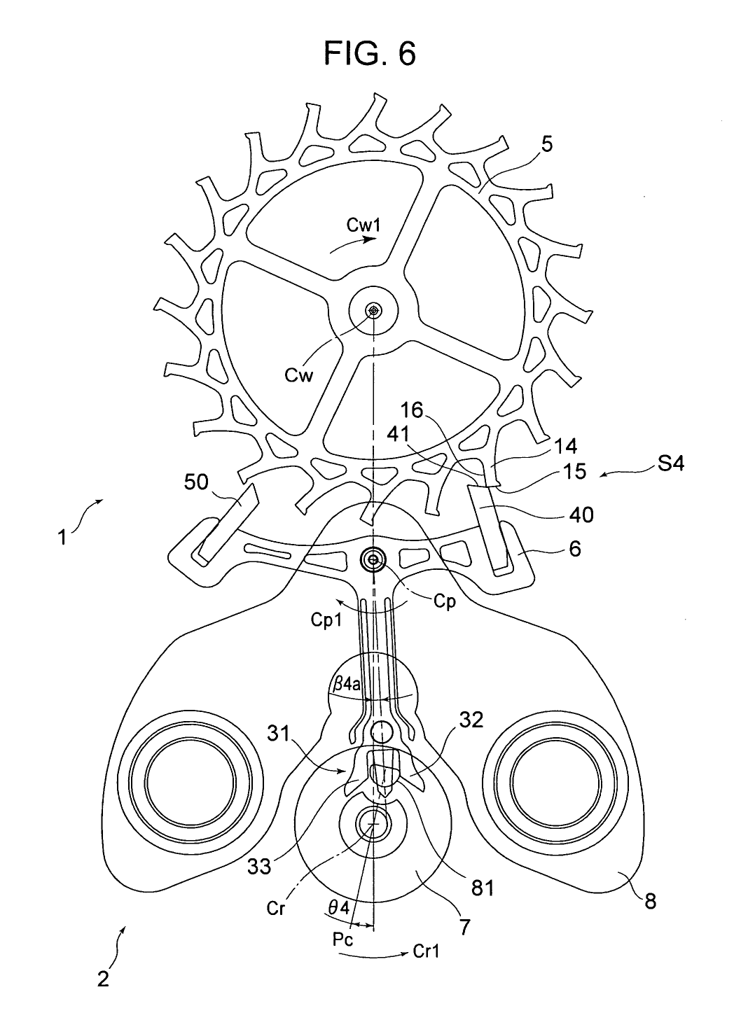

When the engagement of the escape tooth 14 at the locking face 16 is released, the escape wheel 5 comes into contact with the impact face 41 of the entry pallet jewel 40 at the impact face 15 of the escape tooth 14, and the pallet fork 6 is swung in the Cp1 direction around the pallet staff 21 in accordance with the swing of the escape wheel 5 in the Cw1 direction by the torque added to the escape wheel 5 from the spiral spring (not shown), whereby the gutter between the pallet front end portion or the corner 32 of the pallet box 31 at the front end of the pallet shaft 30 and the roller jewel 81 of the balance 7 is removed, and the pallet front end portion (corner) 32 comes into contact with the roller jewel 81. The state S4 shown in FIG. 6 is the state S4 in which an impact is begun, the rotary driving or energy supply of the escape wheel 5 with respect to the balance 7 in the Cr1 direction through the pallet fork 6 is begun. In this impact beginning state S4, the roller jewel 81 has, for example, θ4=about 12.6 degrees at the angle position Pc (θ=θ4), similarly to the state S2, but the slant angle β of the pallet shaft 30 in which, instead of one pallet front end portion 33 of the pallet box 31, the other pallet front end portion or corner 32 is engaged with the roller jewel 81 is β4a=about 2.9 degrees.

The rotary driving or energy supply of the escape wheel 5 with respect to the balance 7 in the Cr1 direction through the pallet fork 6 continues until a state in which the engagement between the impact face 15 of the escape tooth 14 and the impact face 41 of the entry pallet jewel 40 in the pallet fork 6 is released in accordance with the swing of the pallet fork 6 in the Cp1 direction is formed. When this state is formed, the roller jewel 81 in the balance 7 rotationally driven in the Cr1 direction by the pallet front end portion 32 of the pallet box 31 of the pallet fork 6 takes the angle position Pcx (θ=θ5) shown by the reference numeral Pcx in FIG. 2. Here, actually, θ=θ3.

That is, the escape wheel 5 supplies energy to the balance 7 through the pallet fork 6 until the roller jewel 81 reaches the angle position Pcx at which the angle θ=θ5.

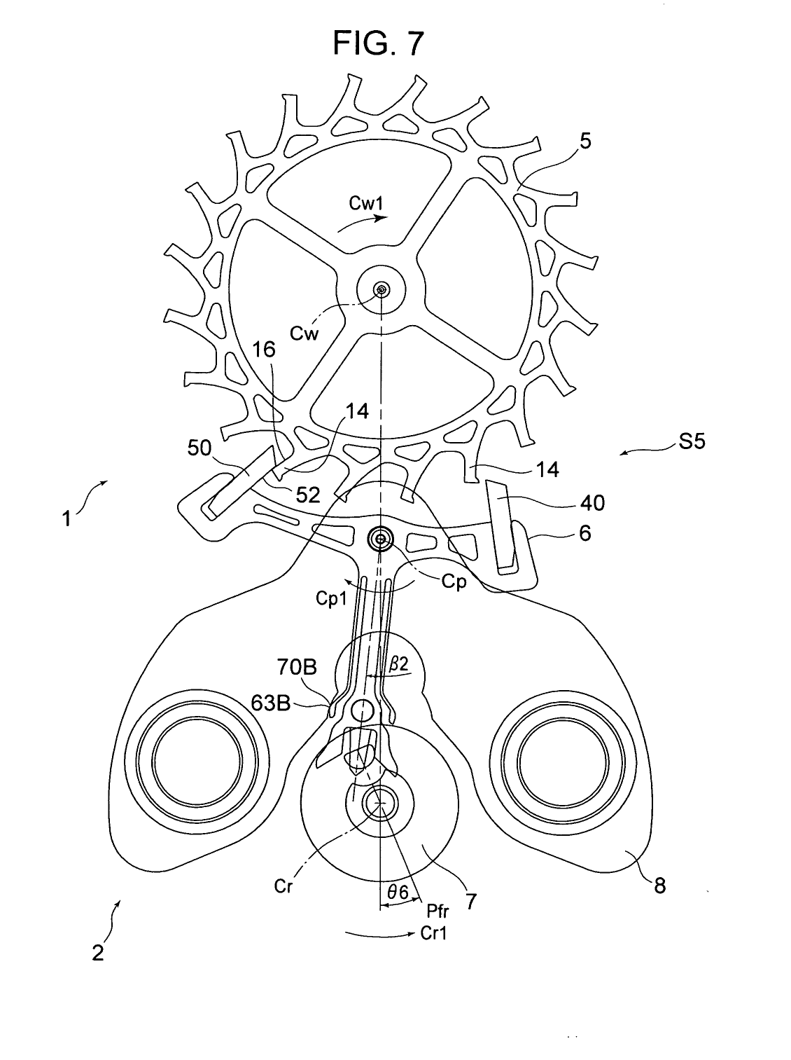

When the impact face 15 of the escape tooth 14 in the escape wheel 5 is released from the impact face 41 of the entry pallet jewel 40, and the energy supply from the escape wheel 5 to the balance 7 is finished, the escape wheel 5 is freely rotated under the action of the torque of the spiral spring (not shown), and the separate escape tooth 14 present ahead of the rotation direction Cw1 of the escape wheel 5 (the third preceding tooth in the example shown in the drawing) is brought into contact with and engaged with the locking face 52 of the exit pallet jewel 50 at the locking face 16, and the pallet fork 6 swung in the Cp1 direction by the escape wheel 5 comes into the contact with the solid state banking pin 70B at the banking pin engaging portion 63B of the elastic arm portion 60B in the pallet shaft 30, and reaches the state S5 in which pressing is begun as shown in FIG. 7. The roller jewel 81 becomes the angle position Pfr, that is, the angle θ=θ6 in this pressing beginning state S5. The angle position Pfr (that is, θ=θ6) is a state in which the banking pin engaging portion of the stiff pallet shaft itself comes into contact with the solid state banking pin 70B, corresponds to the angle position Pir, and θ=θ6=θ2, β=β2 in the case of an ordinary pallet shaft in the related art having no elastic arm portions 60A and 60B.

After that, the banking pin engaging portion 63B of the elastic arm portion 60B of the pallet shaft 30 of the pallet fork 6 is pressed on the solid state banking pin 70B in accordance with the intensity of the torque under the action of the torque from the escape wheel 5 of the escape wheel 14 with respect to the exit pallet jewel 50 in the Cp1 direction, the elastic arm portion 60B is bent, and the roller jewel 81 of the balance 7 reaches the angle position Pfe (angle θ=θ7) corresponding to the bending of the elastic arm portion 60B. That is, a state in which the rotary torque of the escape wheel 5 and the torque by the elastic deformation (bending) of the elastic arm portion 60B match is reached. That is, here, actually, angle θ=θ7=θ1, angle β=β1, and the backward direction swing of the balance 7 can be generated perfectly symmetrically to the above forward direction swing.

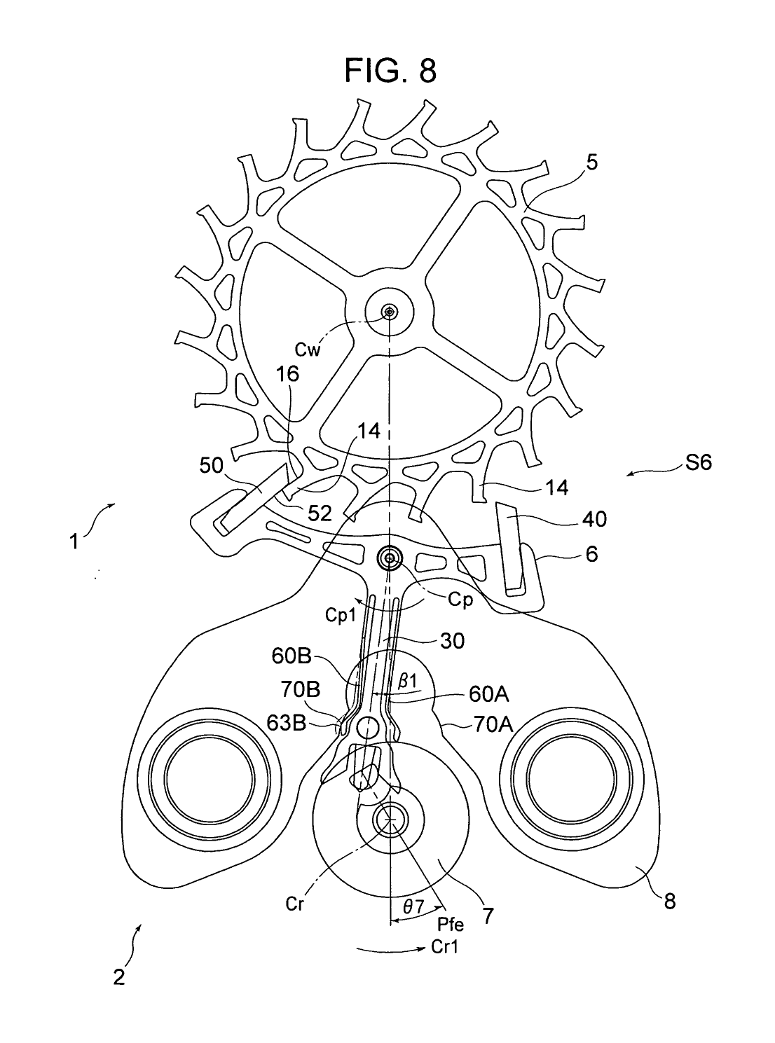

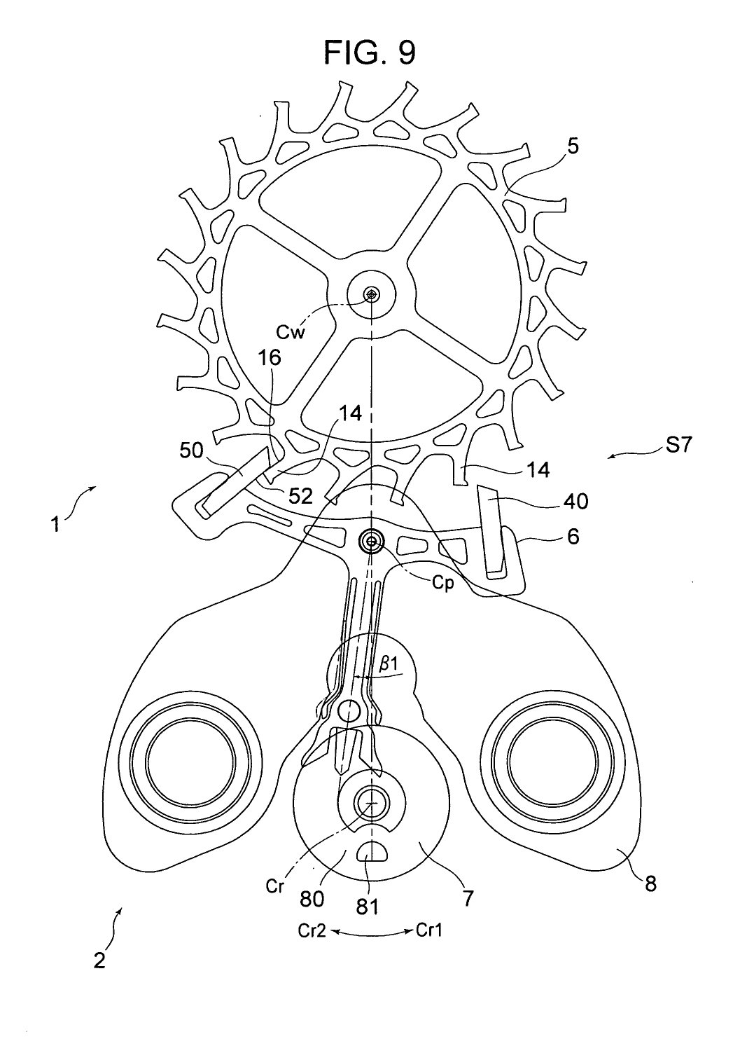

When the matching state S6 of FIG. 8 is reached, since the Cp1 direction swing of the pallet fork 6 is stopped, the roller jewel 81 of the balance 7 is released from the pallet front end portion or the corner 32 of the pallet box 31, and free Cr1 direction rotation begins. FIG. 9 shows a state in which the roller jewel 81 is present at a position where the roller jewel is rotated by 180 degrees (θ=180 degrees) among the free oscillation state S7 of the balance 7. For example, when the maximum oscillation angle θmax is 180 degrees, after that, the balance 7 starts the backward direction rotation Cr2. When the maximum oscillation angle is larger than 180 degrees, the balance 7 is passed through the state S7 where the oscillation angle is 180 degrees as shown in FIG. 9, rotated up to the maximum oscillation angle in the Cr1 direction, reversely rotated, and rotated in the Cr2 direction.

Meanwhile, the operation of the speed controlling escapement mechanism 2 of the anchor escapement 1 after the balance 7 is reversely rotated is substantially the same operation as the above operation except that the restriction and the release of the restriction of (the roller jewel 81 of) the balance 7 are carried out in the Cr2 direction instead of the Cr1 direction by the release of the locking by the exit pallet jewel 50 instead of the entry pallet jewel 40 with respect to the escape tooth 14 and the subsequent impact of the exit pallet jewel 50 of the escape tooth 14 (instead of the entry pallet jewel 40), and the speed controlling escapement mechanism 2 is returned to the state S1 in FIG. 3.

Regarding the backward operation as well, the fact that the elastic arm portion 60B is bent in accordance with the intensity of the torque supplied to the pallet fork 6 from the escape wheel 5 in accordance with the toque of the spiral spring (not shown), and the restriction state is extended by the angular amount (Δθ=θ1-θ2 in this example) when the bending is returned is the same. That is, the increase Δθ (=θ1-θ2) in the restriction angle θc is.

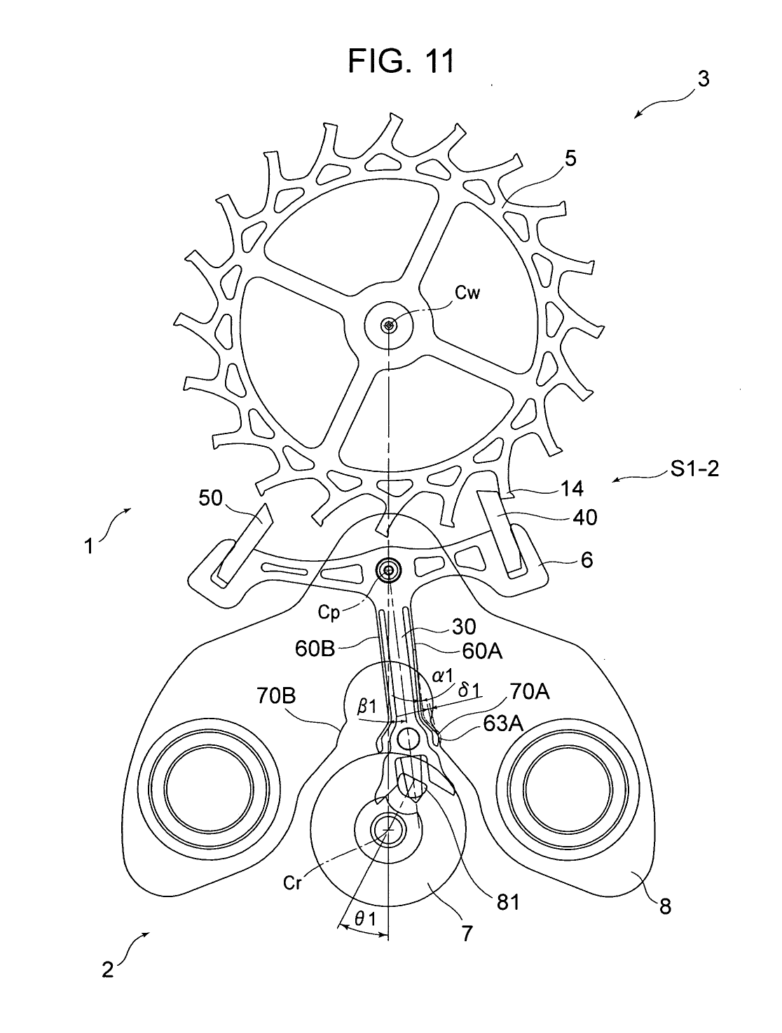

FIG. 3 shows an example in which θ1=θ2+8 degrees=31 degrees. The case in which the torque from the spiral spring (not shown) is changed so that the torque added to the escape wheel 5 is changed in the speed controlling escapement mechanism 2 having the anchor escapement 1 shown in FIG. 3 will be described based on FIG. 11 in addition to FIG. 3.

Next, an example where the torque T added to the escape wheel 5 is decreased will be described.

On the other hand, when the torque added to the escape wheel 5 is relatively small, for example, the state S1-2 in which θ1=θ2+4 degrees=27 degrees is formed as shown in FIG. 11. In the state S1-2, the elastic arm portion 60A is somewhat bent, the bending angle of the elastic arm portion 60A α1=about 1.5 degrees at the slant angle β1 of the pallet shaft 30 of about 6.5 degrees, and the elastic arm portion is deviated about by δ1=about 3×10⁻² mm with respect to the case in which the banking pin engaging portion 63A of the elastic arm portion 60A is not bent.

In comparison to the state S1 in FIG. 3, in the state S1-2, the slant angle β1 of the pallet shaft 30 is decreased by about 1 degree from about 7.5 degrees to about 6.5 degrees, the bending angle α1 of the elastic arm portion 60A is decreased about 2 degrees from about 3.5 degrees to about 1.5 degrees, the position deviation amount δ1 from the case of no bending of the elastic arm portion 60A is decreased by about 3×10⁻² mm from about 6×10⁻² mm to 3×10⁻² mm, and, consequently, the increase Δθ (=θ1-θ2) of the restriction angle θc is decreased by 4 degrees from 8 degrees to 4 degrees.

As described above, in the speed controlling escapement mechanism 2 having the anchor escapement 1, the bending of the elastic arm portion 60 is increased or decreased, and the restriction angle Δθ of the balance 7 is increased or decreased in accordance with an increase or decrease in the torque T. Therefore, even when the oscillation angle is increased or decreased in accordance with an increase or decrease in the torque T, an increase or decrease in the ratio of the free oscillation period can be suppressed. As a result, the escapement error by the change in the torque T can be suppressed to the minimum.

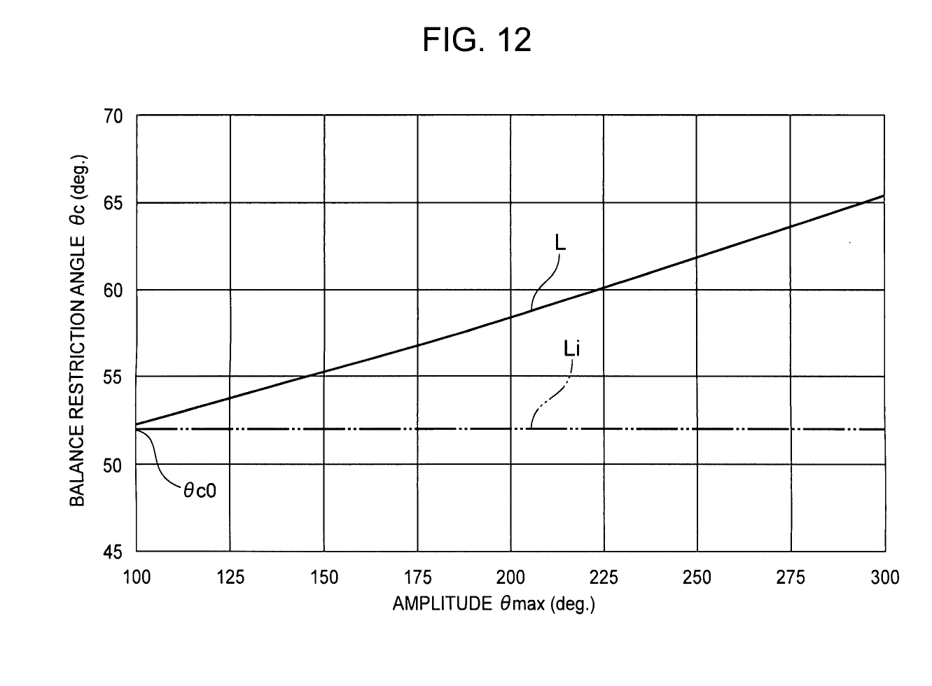

Therefore, the amplitude of the balance 7, that is, the relationship between the oscillation angle θmax and the restriction angle θc of the balance becomes as shown by the graph in FIG. 12. In FIG. 12, the amplitude y of the balance 7 almost corresponds to the torque T added to the escape wheel 5. The balance restriction angle θc is “θc0+Δθ” as described above.

In the speed controlling escapement mechanism having an ordinary anchor escapement in the related art having no elastic arm portion, the balance restriction angle θc0 is not dependent on the torque added to the escape wheel, thus not dependent on the amplitude or oscillation angle θmax of the balance, and constant as shown by the imaginary line Li in FIG. 12. On the other hand, as described in FIGS. 3 and 11, in the speed controlling mechanism 2 having the anchor escapement 1, the balance restriction angle θc is “θc0+Δθ,” the bending amount of the elastic arm portion 60 is increased or decreased in accordance with an increase or decrease in the torque T added to the escape wheel 5, in other words, an increase or decrease in the amplitude or oscillation angle θmax of the balance, and the increase Δθ is increased or decreased. Therefore, in the case of the speed controlling escapement mechanism 2 having the anchor escapement 1, the balance constriction angle θc is increased or decreased almost linearly in accordance with an increase or decrease in the torque T as shown by the solid line L in FIG. 12, in other words, an increase or decrease in the amplitude or oscillation angle θmax of the balance.

For example, the state S1 in which the increase Δθ in the restriction angle θc becomes 8 degrees as in the example of FIG. 3 is formed when the maximum oscillation angle or amplitude θmax is about 225 degrees in the case of the example in FIG. 12. Therefore, in this example, for example, the state in which the free oscillation state like FIG. 9 is formed, and the oscillation angle θ is 180 degrees is a state in the middle of rotation in the Cr1 direction before the maximum oscillation angle θmax reaches 225 degrees. In addition, for example, in the case of the characteristics (the dependency of the amplitude θmax of the restriction angle θc) as shown by the line L in FIG. 12, the increase Δθ of the restriction angle θc is changed in accordance to the maximum oscillation angle or amplitude θmax as the state S1-2 where the increase Δθ of the restriction angle θc becomes 4 degrees as in FIG. 11 is formed when the amplitude θmax=about 170 degrees, and the state where the increase Δθ of the restriction angle θc becomes 10 degrees as in FIG. 11 is formed when the amplitude θmax=about 250 degrees. In the example shown in FIG. 12, the Δθ/θc can be changed to the extent of a maximum of 30%, and Δθ/θc can be changed in a range of about 10% to 30% when an attempt is made to avoid an excessively small range for the amplitude θmax.

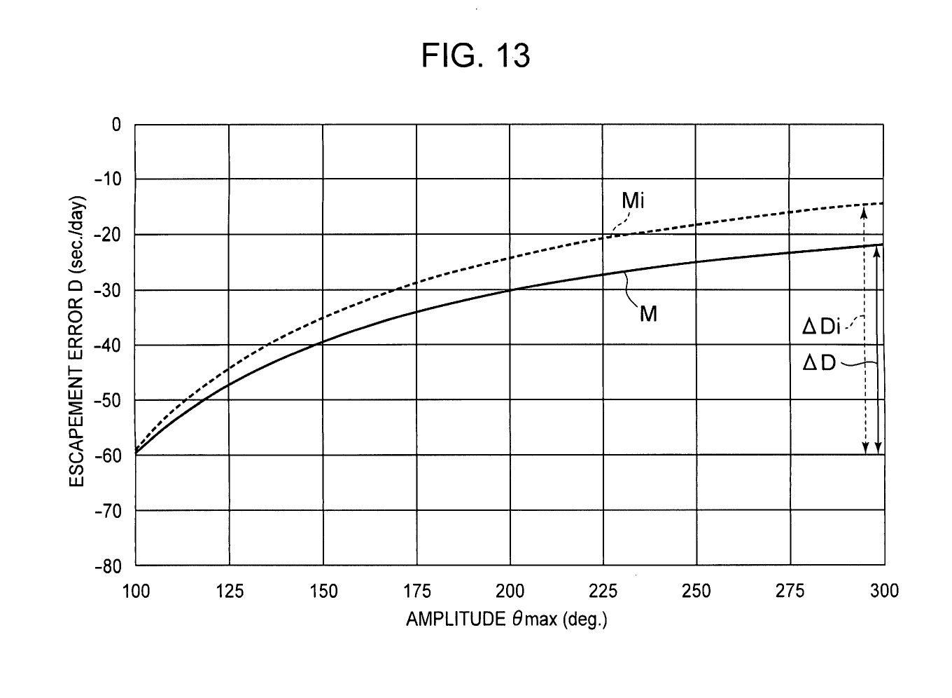

FIG. 13 is a graph showing the relationship between the oscillation angle or amplitude θmax of the balance and the escapement error D.

In FIG. 13, the broken line Mi represents the dependency of the escapement error D on the amplitude θmax in the speed controlling escapement mechanism having an ordinary anchor escapement having no elastic arm portion. It is clear from the curved line Mi that the escapement error D is increased as the amplitude θmax is decreased. That is, in the speed controlling escapement mechanism having an ordinary anchor escapement in the related art having no elastic arm portion, since the balance restriction angle θc0 is not dependent on the maximum oscillation angle (amplitude) θmax of the balance and constant, in this type of speed controlling escapement mechanisms in the related art, the fraction of the balance being restricted during the reciprocal swing (oscillation) of the balance is increased, and the escapement error D is increased as the oscillation angle θmax of the balance is decreased. Therefore, the curved line Mi becomes a left-downward line. Furthermore, since the fraction of the balance being restricted during the reciprocal swing (oscillation) of the balance is abruptly increased when the oscillation angle θmax is decreased, the (negative) slope of the curved line Mi is increased as the oscillation angle θmax is decreased, and the curved line Mi becomes an upward protruding right-upward curve.

In contrast to this, the solid line M shows the dependency of the escapement error D on the amplitude θmax in the speed controlling escapement mechanism 2 having the anchor escapement 1 having the elastic arm portion 60 in FIG. 13.

For example, when the oscillation angle (amplitude) θmax is about 100 degrees, and the torque T applied to the escape wheel 5 is small, the elastic arm portion 60 is actually not bent. In such a case, the situation is the same as when no elastic arm portion 60 is present, the curves D and Di actually match (intersect).

On the other hand, when the torque T applied to the escape wheel 5 is more increased, since the amplitude θmax is also increased, and the bending amount of the elastic arm portion 60 is increased in accordance with the increase in the torque T, the balance restriction angle θc is increased by Δθ. As a result, the lowering of the balance restriction angle θc with respect to the amplitude θmax is suppressed. Therefore, the change in the escapement error D in accordance with the change in the amplitude θmax is decreased in comparison to the curve Mi in the speed controlling escapement mechanism in the related art having an anchor escapement in the related art (when the amplitude is decreased from a state of a large amplitude θmax, the increase in the escapement error D is decreased).

Meanwhile, FIG. 13 shows the absolute value of the escapement error D. For example, when the difference ΔD of the escapement error between the cases in which the amplitudes θmax are 300 degrees and 100 degrees is considered as the dependency ΔD of the escapement error D on the amplitude θmax, the amplitude dependency ΔD of the escapement error D in the speed controlling escapement mechanism 2 having the anchor escapement 1 having the elastic arm portion 60 is smaller than and improved from the amplitude dependency ΔDi of the escapement error in the case of the speed controlling escapement mechanism in the related art having an ordinary anchor escapement in the related art having no elastic arm portion. That is, with a desired state between the amplitudes θmax of 100 degrees and 300 degrees set to the criterion state, the change ΔD in the escapement error D in a case in which the torque added to the escape wheel 5 is changed when the state of the spiral spring is changed from a state in which the amplitude is somewhat larger than the criterion state (for example, a state in which the spiral spring is wound to the maximum extent) to a state in which the amplitude is smaller than the criterion state (a state in which the spiral spring is actually fully loosened) becomes smaller in the case of the speed controlling escapement mechanism 2 having the anchor escapement 1 having the elastic arm portion 60 than in the case of the speed controlling escapement mechanism in the related art having an ordinary anchor escapement in the related art having no elastic arm portion. Here, the decrease in the change ΔD of the escapement error D is realized by an increase or decrease in the bending of the elastic arm portion 60 in accordance with an increase or decrease in the torque T. For example, when the oscillation angle or amplitude θmax of the balance is changed from 300 degrees to 180 degrees, the escapement error is changed by about 3 seconds in comparison to a case in which the restriction angle is constant. Although the absolute value itself of the change is not that large, it is found from the fact that the amplitude dependency can be substantially decreased that the absolute value is totally different in the speed controlling escapement mechanism 2 having the anchor escapement 1 from that in the related art.

Meanwhile, in the anchor escapement 1, a buffering material may be provided between the base end portions 61A and 61B of the elastic arm portions 60A and 60B and the side portions 36A and 36B in the main body 35 of the pallet shaft 30 as shown by the imaginary line 90 in the enlarged view of FIG. 10 in order to prevent the elastic arm portions 60A and 60B from oscillating. This buffering material 90 is made of a material having plasticity that can absorb oscillation.

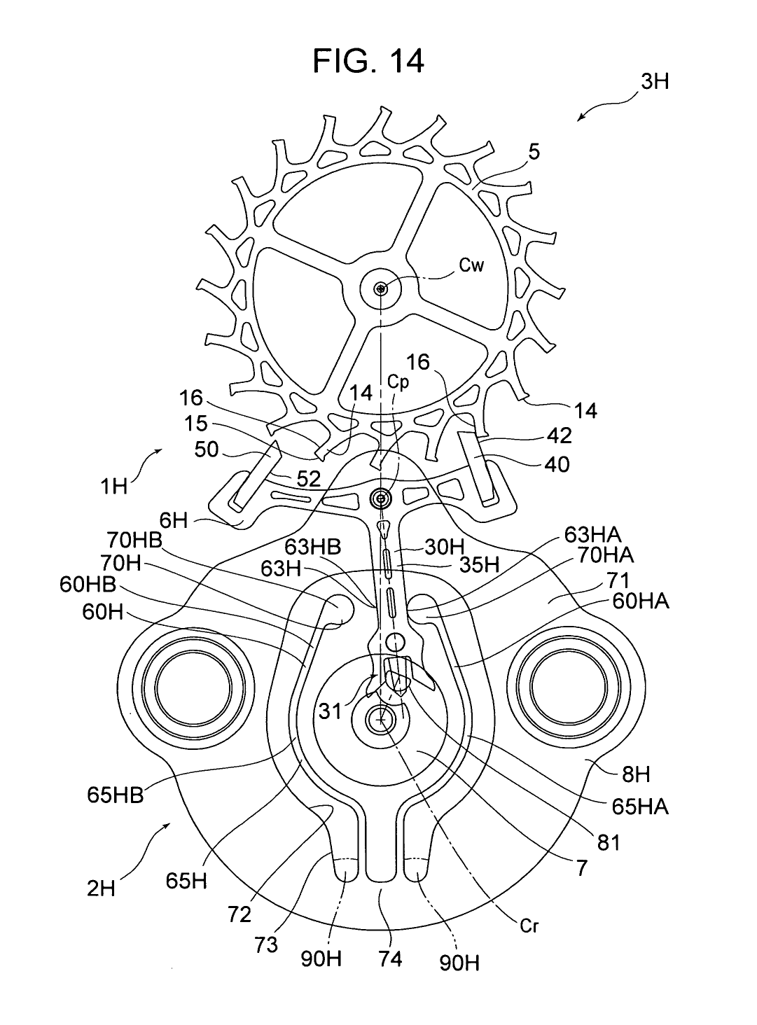

The elastic arm portion may be formed at the solid state banking pin as shown in FIG. 14 instead of being formed at the pallet shaft as long as the elastic arm portion is bent so that the torque added to the escape wheel 5 matches.

FIG. 14 shows a speed controlling escapement mechanism 2H of another example of the invention having an anchor escapement 1H of another example of the invention. In the anchor escapement 1H or the speed controlling escapement mechanism 2H in FIG. 14, the same elements as the elements of the anchor escapement 1 or the speed controlling escapement mechanism 2 shown in FIGS. 1 to 11 are given the same reference numerals, and elements that almost correspond to, but have differences from the elements of the anchor escapement 1 or the speed controlling escapement mechanism 2 are given an additional letter of H behind the same reference numerals.

In the anchor escapement 1H of the speed controlling escapement mechanism 2H of a mechanical watch 3H, the elastic arm portion 60H is formed at the pallet bridge 8H instead of at the pallet shaft 30.

That is, in the pallet fork 6H of the anchor escapement 1H, the pallet shaft 30H includes no elastic arm portion, and the shaft main body 35H acts as the pallet shaft 30H as it is. Meanwhile, the width of the pallet shaft 30H matches the width between the elastic arm portions 60A and 60B in a state in which, for example, the elastic arm portions 60A and 60B in the pallet shaft 30 of the pallet fork 6 in the anchor escapement 1 are not bent. However, the width may be larger or smaller. Both sides at portions close to the pallet box 31 among the pallet shaft 30H form the banking pin engaging portions 63HA and 63HB (denoted by a reference symbol of ‘63H’ when both are not differentiated or are collectively referred to).

In the anchor escapement 1H of the speed controlling escapement mechanism 2H, the pallet bridge 8H includes a pallet bridge main body 71 fixed to a supporting substrate like a ground plane. The pallet bridge main body 71 has an opening or a recess portion 72, and also has elastic arm portions 60HA and 60HB (denoted by a reference symbol of ‘60H’ when both are not differentiated or are collectively referred to) extended almost along the side wall 73 from one side portion 74 of the circumferential wall 73 of the opening or recess portion 72. The elastic arm portions 60HA and 60HB have elastic arm main body portions 65HA and 65HB (denoted by a reference symbol of ‘65H’ when both are not differentiated or are collectively referred to) and solid state banking pins or swollen protrusion portions 70HA and 70HB (denoted by a reference symbol of ‘70H’ when both are not differentiated or are collectively referred to) that protrude inward in a round shape so as to face the banking pin engaging portions 63HA and 63HB of the pallet shaft 30H and act as the pallet engaging portions.

In this example, the rotation central shaft line Cr of the balance 7 is located at the center of the opening or recess portion 72 of the pallet bridge main body 71, and the elastic arm portions 60HA and 60HB are located on the opposite side of the rotation central shaft line Cp of the pallet fork 6H with regard to the rotation central shaft line Cr of the balance 7. Thereby, the elastic arm portions 60HA and 60HB are extended and can be easily bent, and the elastic arm portions 60HA and 60HB of the pallet bridge 8H and the pallet shaft 30H are also easily prevented from interrupting with each other when the elastic arm portions 60HA and 60HB are bent.

In the speed controlling escapement mechanism 2H having the anchor escapement 1H, the elastic arm portion 60HA or 60HB is bent in accordance to the intensity of the torque applied to the escape wheel 5 when the escape tooth 14 of the escape wheel 5 and the pallet jewel 40 or 50 in the pallet fork 6H are engaged with each other at the locking faces 16 and 42 or 16 and 52. That is, the speed controlling escapement mechanism 2H having the anchor escapement 1H functions similarly to the speed controlling escapement mechanism 2 having the anchor escapement 1 except that the elastic bending of the elastic arm portions 60HA and 60HB is generated by engaging the pallet engaging portion 70HA or 70HB of the elastic arm portions 60HA and 60HB of the pallet bridge 8H with the banking pin engaging portions 63HA and 63HB of the pallet shaft 30H of the pallet fork 6H instead of generating elastic bending of the elastic arm portions 60A and 60B by engaging the pallet engaging portion 70A or 70B of the pallet bridge 8 with the banking pin engaging portions 63A and 63B of the elastic arm portions 60A and 60B at both sides of the pallet shaft 30 of the pallet fork 6 in the speed controlling escapement mechanism 2 having the anchor escapement 1. Therefore, herein, detailed description will not be made. Meanwhile, even in the anchor escapement 6H, a buffering material 90H may be provided as shown by the imaginary line 90H.

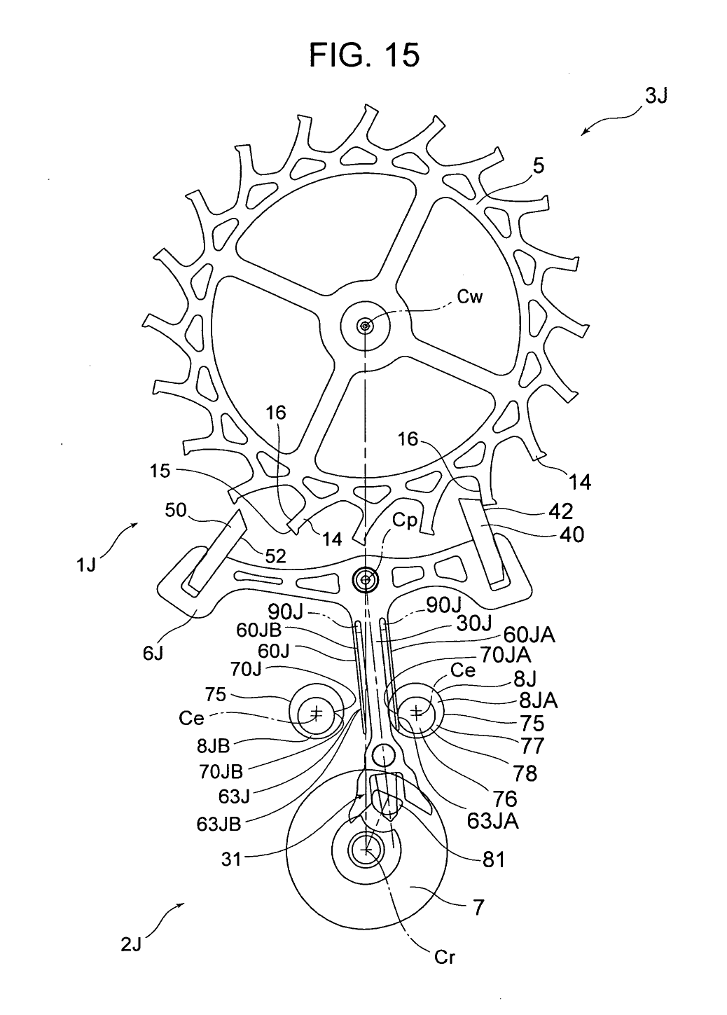

Meanwhile, in the anchor escapement 1 of the speed controlling escapement mechanism 2 shown in FIG. 1 or 3, since the restriction angle θc is increased in accordance with an increase in the amplitude θmax of the balance 7 by providing the elastic arm portions 60A and 60B at the place of the pallet shaft 30, a banking pin that is not bent may be used instead of a solid state banking pin as shown in FIG. 15.

FIG. 15 shows a speed controlling escapement mechanism 2J of still another example of the invention having a pallet escapement 1J of still another example of the invention. In the anchor escapement 1J or the speed controlling escapement mechanism 2J in FIG. 15, the same elements as the elements of the anchor escapement 1 or the speed controlling escapement mechanism 2 shown in FIGS. 1 to 11 are given the same reference numerals, and elements that almost correspond to, but have differences from the elements of the anchor escapement 1 or the speed controlling escapement mechanism 2 are given an additional letter of J after the same reference numerals.

In an anchor escapement 1J of a speed controlling escapement mechanism 2J of a mechanical watch 3J, the pallet bridge banking pin is composed of banking pins 8JA and 8JB (denoted by a reference symbol of ‘8J’ when both are not differentiated or are collectively referred to), and portions 70JA and 70JB (denoted by a reference symbol of ‘70J’ when both are not differentiated or are collectively referred to) facing elastic arm portions 60JA and 60JB (denoted by a reference symbol of ‘60J’ when both are not differentiated or are collectively referred to) at both sides of the pallet shaft 30J of the banking pins 8JA and 8JB form the pallet engaging portions.

Meanwhile, each of the banking pins 8JA and 8JB, that is, the banking pin 8J has an eccentric tube 77 and a center side pin-shaped portion 76 fastened to the eccentric tube 77 at the bottom end portion, and the eccentric tube 77 has a cylindrical outer circumferential face 75 and a column-shaped hole 78 that define the cylindrical faces eccentric with respect to the outer circumferential face 75. The eccentric tube 77 is rotatably mounted on a supporting substrate like a ground plane around the central shaft line Ce of the outer circumferential face 75. Therefore, when the eccentric tube is rotated around the central shaft line Ce, the column-shaped central side pin-shaped portion 76 is swung around the eccentric rotation central shaft line Ce, and the distance between the pallet engaging portion 70J present at the position facing the pallet shaft 30J of the pallet port 6J among the outer circumferential face of the center side pin-shaped portion 76 and the pallet shaft 30J (in other words, the distance between the pallet engaging portion 70J and the central shaft line Ce) is changed. Thereby, the restriction angle θc can be adjusted independently from the torque T. The eccentric tube 77 and the center side pin-shaped portion 76 may be an integrated substance.

The pallet fork 6J of the anchor escapement 1J is the same as the pallet fork 6 of the anchor escapement 1 in terms of having the elastic arm portions 60JA and 60JB in the pallet shaft 30J. However, while the elastic arm portion 60 is engaged with the pallet engaging portion 70A or 70B composed of the solid state banking pin in the pallet fork 6 of the anchor escapement 1, the elastic arm portion 60J is engaged with the pallet engaging portion 70JA or 70JB of the banking pin 8J in the pallet fork 6J in the anchor escapement 1J, and therefore the shape of the elastic arm portion 60J is somewhat different from the shape of the elastic arm portion 60 in this example. That is, in this example, the elastic arm portion 60JA or 60JB is brought into contact with or engaged with the circumferential face portion of the banking pin 60JA or 60JB that composes the pallet engaging portion 63JA or 63JB at the banking pin engaging portion 63JA or 63JB (denoted by a reference symbol of ‘63J’ when both are not differentiated or are collectively referred to) located at the front end portion of the linearly extended elastic arm portion 60JA or 60JB.

The anchor escapement 1J of the speed controlling escapement mechanism 2J operates in the same way as the anchor escapement 1 of the speed controlling escapement mechanism 2 in other aspects. Therefore, even herein, detailed description will not be made. Meanwhile, a buffering material 90J may be provided even in this anchor escapement 1J as shown by the imaginary line 90J.

What is claimed is:

1. An anchor escapement, comprising:
an escape wheel having an escape gear;
a pallet fork that is swingably supported around a pallet staff, engaged with or disengaged from the escape gear at an entry pallet jewel and an exit pallet jewel at both ends of a pallet base, and can be engaged with or disengaged from a roller jewel of a roller at a fork-shaped pallet front end portion present at the front end of a pallet shaft having banking pin engaging portions at both sides; and
pallet bridges that are engaged with the banking pin engaging portions at a pair of the pallet engaging portions and define the swing range of the pallet fork,
wherein any one member of the pallet shaft and the pallet bridge has elastic arm portions that are connected to the side wall of the above member at the base end portion and extended along the side wall from the base end portion to the front end portion, the front end portion of the elastic arm portion forms the engaging portion of the above member, and the elastic arm portion is elastically deformed and the engaging portion at the front end of the elastic arm portion is engaged with the engaging portion of the other member of the pallet shaft and the pallet bridge in a state in which the pallet fork fixes the escape gear at the pallet jewel against a torque.

2. The anchor escapement according to claim 1,
wherein a buffering material that absorbs oscillation is provided between the side wall of the above member and the elastic arm portion connected to the side wall.

3. The anchor escapement according to claim 1,
wherein the elastic arm portion is formed at both side portions of the pallet shaft.

4. The anchor escapement according to claim 2,
wherein the elastic arm portion is formed at both side portions of the pallet shaft.

5. The anchor escapement according to claim 3,
wherein the elastic arm portion is extended from the end portion close to the pallet staff among the respective side portions of the pallet shaft along both side portions of the pallet shaft toward the front end portion of the pallet shaft,
a gap is formed between each elastic arm portion and the side portion facing the elastic arm portion of the pallet shaft, the elastic arm portion located ahead of the swing direction is elastically deformed when the pallet fork is swung around the pallet staff, and
the pallet fork is engaged with the pallet engaging portion adjacent to the pallet bridge at the external face of the portion close to the front end of the elastic arm portion.

6. The anchor escapement according to claim 4,
wherein the elastic arm portion is extended from the end portion close to the pallet staff among the respective side portions of the pallet shaft along both side portions of the pallet shaft toward the front end portion of the pallet shaft,
a gap is formed between each elastic arm portion and the side portion facing the elastic arm portion of the pallet shaft, the elastic arm portion located ahead of the swing direction is elastically deformed when the pallet fork is swung around the pallet staff, and
the pallet fork is engaged with the pallet engaging portion adjacent to the pallet bridge at the external face of the portion close to the front end of the elastic arm portion.

7. The anchor escapement according to claim 3,
wherein the pallet bridge is composed of a banking pin.

8. The anchor escapement according to claim 4,
wherein the pallet bridge is composed of a banking pin.

9. The anchor escapement according to claim 5,
wherein the pallet bridge is composed of a banking pin.

10. The anchor escapement according to claim 6,
wherein the pallet bridge is composed of a banking pin.

11. The anchor escapement according to claim 1,
wherein the pallet bridge has a solid state banking pin.

12. The anchor escapement according to claim 2,
wherein the pallet bridge has a solid state banking pin.

13. The anchor escapement according to claim 3,
wherein the pallet bridge has a solid state banking pin.

14. The anchor escapement according to claim 4,
wherein the pallet bridge has a solid state banking pin.

15. The anchor escapement according to claim 5,
wherein the pallet bridge has a solid state banking pin.

16. The anchor escapement according to claim 6,
wherein the pallet bridge has a solid state banking pin.

17. The anchor escapement according to claim 1,
wherein the pallet bridge has a solid state banking pin, and the elastic arm portion is formed at both side wall portions of a recess portion of a solid state banking pin.

18. The anchor escapement according to claim 1,
wherein the elastic arm portion is formed by UV-LIGA, reactive ionic etching, or laser processing.

19. A speed controlling escapement mechanism comprising the anchor escapement according to claim 1.

20. A mechanical watch comprising the anchor escapement according to claim 1.
